(19) United States
(12) Patent Application Publication
(10) Pub. No.: US 2024/0000007 A1
(43) Pub. Date: Jan. 4, 2024

(54) NOISE-REDUCTION MOWER AND BLADE

(71) Applicant: HONDA MOTOR CO., LTD., Tokyo (JP)

(72) Inventors: Mai Kurihara, Wako-shi (JP); Shingo Tsuruoka, Wako-shi (JP); Fumio Minami, Wako-shi (JP); Kouki Tsuruda, Wako-shi (JP); Shiho Takashima, Wako-shi (JP)

(21) Appl. No.: 18/369,227

(22) Filed: Sep. 18, 2023

Related U.S. Application Data
(63) Continuation of application No. 17/206,181, filed on Mar. 19, 2021.

(30) Foreign Application Priority Data
Mar. 23, 2020 (JP) 2020-051732

(51) Int. Cl. A01D 34/73; A01D 34/685; A01D 34/82

(52) U.S. Cl. CPC A01D 34/73; A01D 34/685; A01D 34/826; A01D 2101/00

(57) ABSTRACT

A mower capable of reducing noise generated by rotation of a cutter blade containing an upper cutter blade and a lower cutter blade inside a housing. The lower cutter blade has a wing portion and a wing chamfered portion. The wing portion overhangs upward from a second rear end portion of the lower cutter blade on an opposite side in a rotational direction, at both end portions in a longitudinal direction. The wing chamfered portion is chamfered so that a wing outer end portion of the wing portion is inclined from an upper surface to a lower surface.

### CROSS-REFERENCE TO RELATED APPLICATIONS

This application is a Continuation of application Ser. No. 17/206,181 filed on Mar. 19, 2021, the content of which is incorporated herein by reference.

Priority is claimed on Japanese Patent Application No. 2020-051732, filed Mar. 23, 2020, the content of which is incorporated herein by reference.

### FIELD OF THE INVENTION

### Background of the Invention

The present invention relates to a mower.

### Description of Related Art

A mower mows grass by rotating a cutter blade housed in a housing with an open bottom along the grass. There is a cutter blade which extends radially in two directions with respect to a rotary shaft, and in which left and right cutters are formed on a leading edge at the two end portions in a longitudinal direction, and left and right air lift portions (hereinafter referred to as wing portions) extend in a curved shape from a leading edge to sides behind and above (see, for example, Patent Document 1 (Japanese Patent No. 6151659)).

The left and right wing portions of the cutter blade generate a swirling flow or an upward current of air, which enables fine cutting of grass inside the housing.

However, mowers of the related art generate noise due to rotation of the cutter blade, and there is room for improvement from this point of view. In particular, noise suppression is important where the mower is used.

An object of the present invention is to provide a mower in which the noise generated by the rotation of a cutter blade can be reduced.

### SUMMARY OF THE INVENTION

The mower of the present invention has the following configuration.

(1) A mower (e.g., a mower 10 of the embodiment) according to an aspect of the present invention is equipped with a housing with an open bottom (e.g., a housing 11 of the embodiment), a rotary shaft (e.g., a rotary shaft 16a of the embodiment) supported in a vertical direction inside the housing, and a cutter blade (e.g., a lower cutter blade 15 of the embodiment) which is housed inside the housing to be rotatable with the rotary shaft as a rotation center and extends from the rotary shaft to two sides in a radial direction, in which the cutter blade has a wing portion (e.g., a wing portion 42 of the embodiment) which overhangs upward from a rear end portion (e.g., a second rear end portion 47 of the embodiment) on a side of the cutter blade opposite to the rotational direction on a side opposite to a rotational direction, at both end portions in a longitudinal direction (e.g., both end portions 45 in the longitudinal direction of the embodiment), and a wing chamfered portion (e.g., a wing chamfered portion 51 of the embodiment) in which a wing outer end portion (e.g., a wing outer end portion 53 of the embodiment) located on an outer side in the radial direction of the wing portion is chamfered to be inclined from an upper surface (e.g., an upper surface 15a of the embodiment) to a lower surface (e.g., a lower surface 15b of the embodiment) toward the outward side in the radial direction.

According to the aspect of (1), the wing portion overhangs upward from both end portions of the cutter blade in the longitudinal direction on the side opposite to the rotational direction. The wing chamfered portion is provided at the wing outer end portion of the wing portion. Therefore, in a state in which the cutter blade rotates, the air guided upward along the wing portion can be made to smoothly flow outward by the wing chamfered portion. As a result, turbulence in the air flow can be suppressed to a low level, and noise such as airflow noise generated by the rotation of the cutter blade can be reduced.

Incidentally, for example, the grass mown with the cutter blade is guided by the swirling flow and the upward current inside the housing, and the grass is finely cut by the cutter blade. Here, the wing chamfered portion of the wing outer end portion is formed to have a thin leading edge. As a result, the grass inside the housing can be cut into smaller pieces with the wing chamfered portion.

By finely cutting the grass that has entered between the housing and the wing outer end portion at the wing chamfered portion, it is possible to prevent the grass from being caught between the housing and the wing outer end portion.

(2) In the mower according to the aspect of (1), the cutter blade may have a blade outer end portion (e.g., a blade outer end portion 54 of the embodiment) which extends to the opposite side in the rotational direction from an outer end of a front end portion (e.g., a second front end portion 46 of the embodiment) on the rotational direction side to the wing outer end portion, and is continuous with the wing outer end portion, at both end portions in the longitudinal direction, and the blade outer end portion and the front end portion may intersect to form a corner portion (e.g., a corner portion 56 of the embodiment).

According to the aspect of (2), the blade outer end portion is continuous with the wing outer end portion, and the blade outer end portion and the front end portion intersect to form a corner portion. Therefore, it is possible to firmly catch the grass at the corner portions and cut the caught grass with the cutter blade. As a result, better cutting characteristics for the grass can be secured, and energy saving for the mower can be realized.

By making the blade outer end portion and the front end portion intersect to form a corner portion, the shape of the intersecting corner portion can be simplified and the corner portion can be easily machined.

(3) In the mower according to the aspect of (2), the cutter blade mower may have a blade chamfered portion (e.g., a blade chamfered portion 52 of the embodiment) in which the blade outer end portion is chamfered to be inclined from the upper surface toward the lower surface toward the outward side in the radial direction, similarly to the wing chamfered portion.

According to the aspect of (3), the blade chamfered portion similar to the wing chamfered portion is formed at the blade outer end portion. Therefore, in a state in which the cutter blade rotates, the air guided along the cutter blade can be made to smoothly flow outward by the wing chamfered portion and the blade chamfered portion. As a result, turbulence in the air flow can be suppressed to a low level, and noise such as airflow noise generated by the rotation of the cutter blade can be further reduced.

The leading edge of the wing chamfered portion and the blade chamfered portion is thinly formed. As a result, the grass guided by the swirling flow and the upward current inside the housing can be cut more finely by the wing chamfered portion and the blade chamfered portion.

By finely cutting the grass that has entered between the housing and the wing outer end portion or between the housing and the blade chamfered portion with the wing chamfered portion and the blade chamfered portion, it is possible to more satisfactorily prevent the grass from being caught between the housing and the wing outer end portion.

(4) In the mower according to any one of aspects of (1) to (3), two cutter blades (e.g., an upper cutter blade 14 and a lower cutter blade 15 of the embodiment) may be provided on an upper side and a lower side of the rotary shaft, and the cutter blade may be a lower cutter blade (e.g., the lower cutter blade 15 of the embodiment).

According to the aspect of (4), the cutter blade is configured so that the wing chamfered portion is chamfered to be inclined downward, and the blade chamfered portion is chamfered to be inclined downward. Therefore, even if another cutter blade is provided on the side above the cutter blade, the air guided along the cutter blade can be made to smoothly flow outward by the wing chamfered portion and the blade chamfered portion. As a result, turbulence in the air flow can be suppressed to a small extent, and noise such as wind noise generated by the rotation of the cutter blade can be further reduced.

The cutter blade is formed to have a wing portion, and generates a swirling flow and an upward current due to the wing portion. As a result, by using the cutter blade as the lower cutter blade, the grass can be guided to the upper cutter blade.

(5) In the mower according to the aspect of (4), the upper cutter blade may have an upper blade outer chamfered portion (e.g., a first blade outer chamfered portion 32 of the embodiment) in which an upper outer end portion (e.g., a first outer end portion 37 of the embodiment) located on the outer side in the radial direction is chamfered to be inclined from the lower surface (e.g., a lower surface 14b of the embodiment) to the upper surface (e.g., an upper surface 14a of the embodiment) outward in the radial direction, at both end portions in the longitudinal direction (e.g., both end portions 35 in the longitudinal direction of the embodiment).

According to the aspect of (5), the blade outer chamfered portion is provided at the upper outer end portion of the upper cutter blade. Therefore, in a state in which the upper cutter blade rotates, the air guided along the upper cutter blade can be allowed to smoothly flow outward by the blade outer chamfered portion. As a result, turbulence in the air flow can be suppressed to a small extent, and noise such as wind noise generated by the rotation of the upper cutter blade can be reduced.

The blade outer chamfered portion is formed to have a thin leading edge. As a result, the grass guided by the swirling flow and the upward current inside the housing can be further finely cut by the blade outer chamfered portion.

By finely cutting the grass that has entered between the blade outer chamfered portion with the blade outer chamfered portion, it is possible to better prevent the grass from being caught between the blade outer chamfered portion. Therefore, energy saving of the mower can be realized.

(6) In the mower according to the aspect of (5), the upper cutter blade may have a blade rear chamfered portion (e.g., a blade rear chamfered portion 33 of the embodiment) in which an upper rear end portion (e.g., a first rear end portion 38 of the embodiment) located on the opposite side in the rotational direction is chamfered to be inclined from the lower surface to the upper surface toward the opposite side in the rotational direction.

According to the aspect (6), the blade rear chamfered portion is provided at the rear end portion of the upper cutter blade. Therefore, in a state in which the upper cutter blade rotates, the air guided along the upper cutter blade can be allowed to smoothly flow to the rear of the rotation by the blade rear chamfered portion. As a result, the turbulence of the air flow can be suppressed to a small extent, and noise such as wind noise generated by the rotation of the upper cutter blade can be further reduced.

According to the present invention, the noise generated by the rotation of the cutter blade can be reduced by having the wing chamfered portion of the wing portion at the wing outer end portion.

### BRIEF DESCRIPTION OF THE DRAWINGS

FIG. 1 is a side view showing a mower according to an embodiment of the present invention.

FIG. 2 is a side view showing an upper cutter blade and a lower cutter blade of the embodiment.

FIG. 3 is a plan view showing an upper cutter blade of the embodiment.

FIG. 4 is a cross-sectional view taken along a line IV-IV of FIG. 3.

FIG. 5 is a cross-sectional view taken along a line V-V of FIG. 3.

FIG. 6 is a perspective view showing a lower cutter blade of the embodiment.

FIG. 7 is a cross-sectional view taken along a line VII-VII of FIG. 6.

FIG. 8 is a cross-sectional view taken along a line VIII-VIII of FIG. 6.

FIG. 9 is a plan view showing an upper cutter blade and a lower cutter blade of the embodiment.

FIG. 10 is a cross-sectional view taken along a line XX of FIG. 9.

### DETAILED DESCRIPTION OF THE INVENTION

Hereinafter, embodiments of the present invention will be described with reference to the drawings. The terms “front”, “rear”, “left”, “right”, “top”, and “bottom” conform to the orientation as seen by an operator.

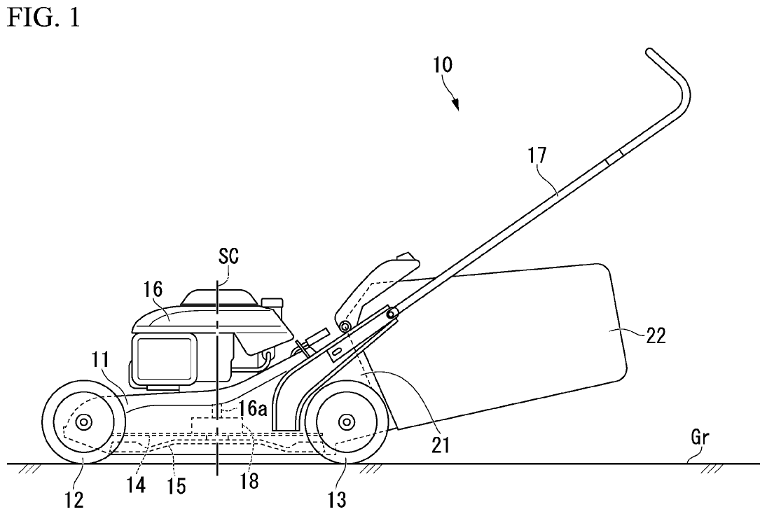

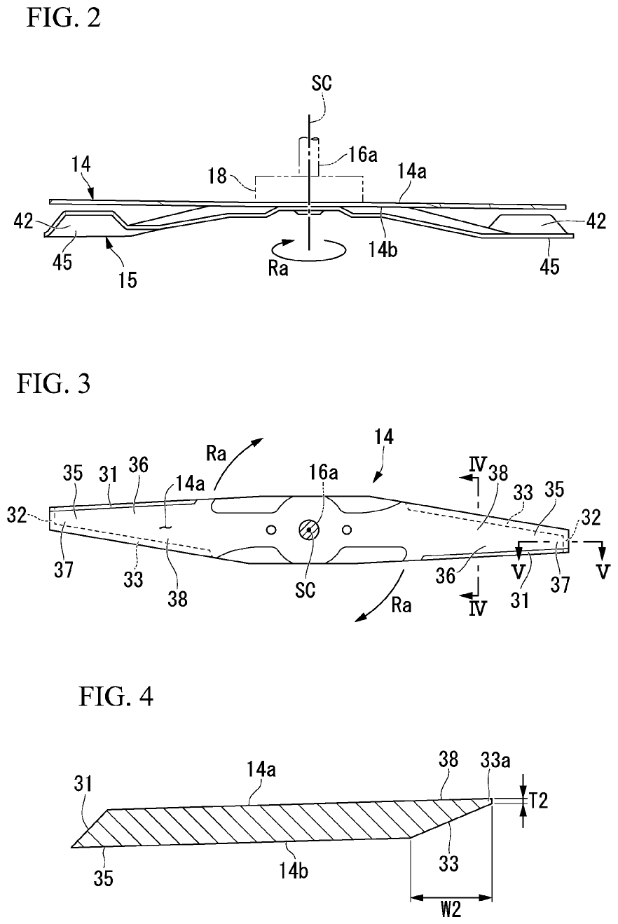

As shown in FIGS. 1 and 2, a mower 10 is a walking self-propelled work machine that cuts grass with a rotary-type blade. The mower 10 is equipped with a housing 11, left and right front wheels 12, left and right rear wheels 13, an upper cutter blade 14 and a lower cutter blade (a cutter blade) 15 for cutting grass, an engine (a power source) 16, and an operation handle 17. The left and right front wheels 12 are provided on a front part of the housing 11. The left and right rear wheels 13 are provided on a rear part of the housing 11. The upper cutter blade 14 and the lower cutter blade 15 are housed inside the center of the housing 11. The engine 16 is provided above the housing 11. The manipulation handle 17 extends rearward from the housing 11. Although the engine 16 is exemplified as the power source of the mower 10, as another example, for example, an electric motor may be used as the power source.

The mower 10 cuts grass by rotating the upper cutter blade 14 and the lower cutter blade 15 using the engine 16, and generates an air flow (swirling flow) inside the housing 11. The mower 10 finely cuts the grass that is cut by the upper cutter blade 14 and the lower cutter blade 15 inside the housing 11 using the generated swirling flow and sends the mown grass to a mown grass storage body 22 for storage. Here, the grass cut by the upper cutter blade 14 and the lower cutter blade 15 may be referred to as “mown grass”.

The housing 11 is a downward open housing in which only a lower end surface (a surface facing a lawn Gr) is completely open. The housing 11 has a scroll portion for directing the mown grass, which is cut by the upper cutter blade 14 and the lower cutter blade 15, toward a mown grass discharge passage 21, while making a swirling motion due to the swirling flow. That is, the housing 11 is a spiral case (scroll case) formed in a spiral shape in a plan view.

A mown grass storage body 22 such as a glass bag can be attached to a rear end of the mown grass discharge passage 21. The mown grass is sent to the mown grass discharge passage 21, while rotating around an output shaft (hereinafter referred to as a rotary shaft) 16a inside the housing 11, and after the mown grass discharge passage 21, is stored in the mown grass storage body 22.

The housing 11 also serves as a device body. That is, the engine 16 is superimposed on the upper surface of the housing 11, and the superimposed engine 16 is integrated with the upper surface of the housing 11 by bolts. The rotary shaft 16a of the engine 16 extends downward toward the lawn Gr inside the housing 11.

That is, the rotary shaft 16a is located inside the housing 11 and is supported in a state of extending in a vertical direction of the housing 11. As a result, the rotary shaft 16a is supported substantially perpendicularly with respect to a horizontal lawn (i.e., the ground) Gr.

Two cutter blades (the upper cutter blade 14 and the lower cutter blade 15) are attached to the upper side and the lower side of the rotary shaft 16a via the clutch 18 in a state of being housed inside the housing 11. That is, the upper cutter blade 14 and the lower cutter blade 15 are attached to the lower part of the clutch 18 in a state in which the lower cutter blade 15 overlaps the upper cutter blade 14 from below. The upper cutter blade 14 is disposed with the upper surface 14a facing upward. The lower cutter blade is disposed with the upper surface 15a facing upward.

In this state, by driving the engine 16 to rotate the rotary shaft 16a, the upper cutter blade 14 and the lower cutter blade 15 rotate in a rotational direction Ra in a circumferential direction centered on the rotary shaft 16a. Hereinafter, the rotational direction Ra of the upper cutter blade 14 and the lower cutter blade 15 may be simply referred to as a “rotational direction Ra”.

The upper cutter blade 14 and the lower cutter blade 15 are supported inside the housing 11 to be rotatable in the circumferential direction with the rotary shaft 16a (an axis center SC) as the center of rotation.

As shown in FIGS. 3 to 5, the upper cutter blade 14 is an elongated member having a substantially flat plate shape in a plan view extending in two radial directions with respect to the rotary shaft 16a (axis center SC). That is, the upper cutter blade 14 is a member having substantially a strip shape in a plan view. More specifically, the upper cutter blade 14 is made up of a flat plate that is radially straight with respect to the rotary shaft 16a (axis center SC).

The upper surface 14a of the upper cutter blade 14 faces upward in the axial direction of the rotary shaft 16a. The lower surface 14b of the upper cutter blade 14 faces downward in the axial direction of the rotary shaft 16a.

The upper cutter blade 14 has a pair of first cutting portions 31, a pair of first blade outer chamfered portions (upper blade outer chamfered portions) 32, and a pair of blade rear chamfered portions 33. The first cutting portion 31 extends in the longitudinal direction along a first front end portion 36 located on the rotational direction Ra side. The cross section of the first cutting portion 31 is formed in a tapered shape to be inclined downward from the upper surface 14a to the lower surface 14b in the rotational direction.

The first blade outer chamfered portion 32 is formed at a first outer end portion (upper outer end portion) 37 located on the outer side in the radial direction with respect to the rotary shaft 16a (axis center SC), at both end portions 35 and 35 of the upper cutter blade 14 in the longitudinal direction. The first outer end portion 37 is formed along the circumferential direction centered on the rotary shaft 16a (axis center SC). That is, since the first outer end portion 37 is chamfered to be inclined upward and outward from the lower surface 14b to the upper surface 14a toward the outer side in the radial direction, the cross section of the first blade outer chamfered portion 32 is formed in a tapered shape.

In the first blade outer chamfered portion 32, for example, a thickness T1 of a leading edge 32a is set as thin as 0.1 to 1.0 mm, and a chamfered width W1 is set as 5 to 10 mm. This enables the inclined surface of the first blade outer chamfered portion 32 to be smoothly inclined with respect to the lower surface 14b of the upper cutter blade 14. The first blade outer chamfered portion 32 may be formed in a curved shape that bulges downward.

The blade rear chamfered portion 33 extends along a first rear end portion (upper rear end portion) 38 located on a side opposite to the rotational direction Ra. The first rear end portion 38 is formed to be inclined toward the first blade outer chamfered portion 32 in a plan view. The cross section of the blade rear chamfered portion 33 is formed in a tapered shape, by chamfering the first rear end portion 38 to be inclined upward from the lower surface 14b to the upper surface 14a toward the side opposite to the rotational direction.

In the blade rear chamfered portion 33, for example, a thickness T2 of the leading edge 33a is set to be as thin as 0.1 to 1.0 mm, and a chamfered width W2 is set as to 10 mm. This enables the inclined surface of the blade rear chamfered portion 33 to be inclined smoothly with respect to the lower surface 14b of the upper cutter blade 14. The blade rear chamfered portion 33 may be formed in a curved shape that bulges downward.

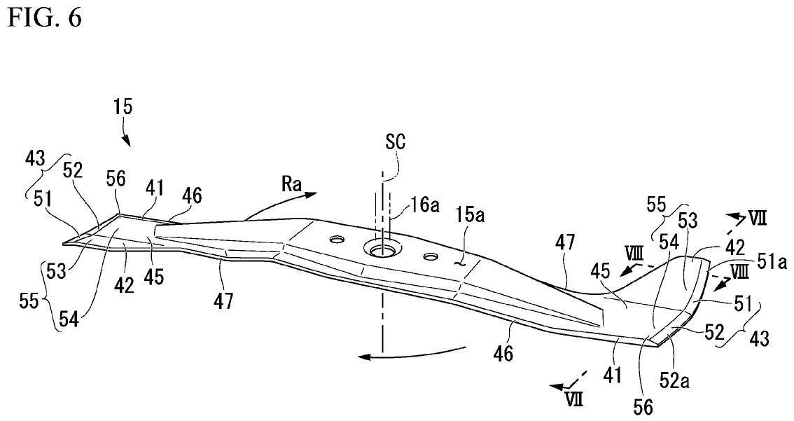

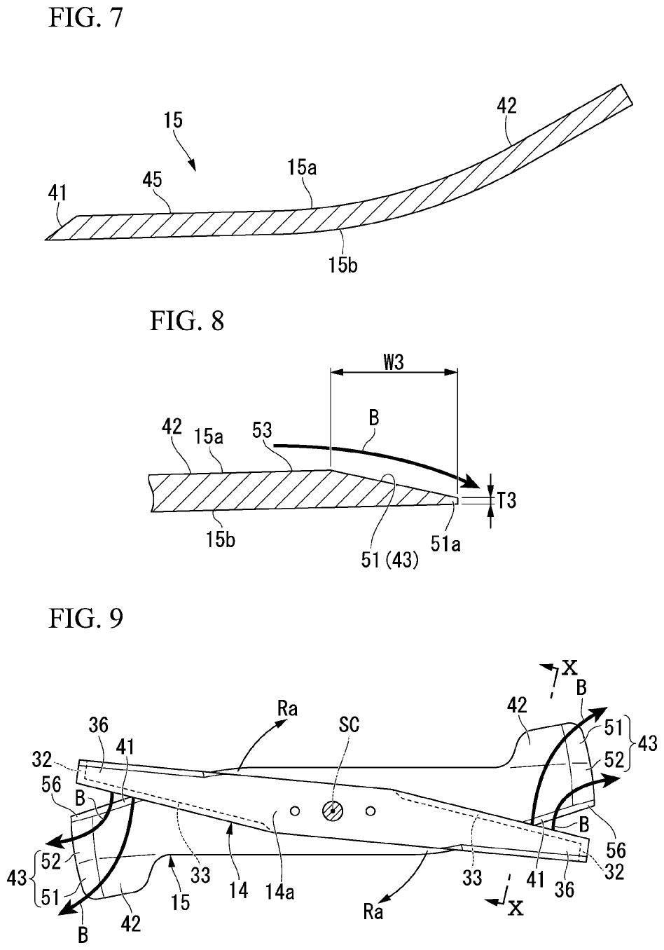

As shown in FIGS. 6 to 8, the lower cutter blade 15 is an elongated member having a substantially flat plate shape in a plan view extending in both radial directions with respect to the rotary shaft 16a (axis center SC). That is, the lower cutter blade 15 is a member having a substantially strip shape in a plan view. More specifically, the lower cutter blade 15 is formed by a flat plate that is substantially straight in the radial direction with respect to the rotary shaft 16a (axis center SC) so that the central portion in the longitudinal direction is curved upward.

The upper surface 15a of the lower cutter blade 15 faces upward in the axial direction of the rotary shaft 16a. The lower surface 15b of the lower cutter blade 15 faces downward in the axial direction of the rotary shaft 16a.

The lower cutter blade 15 has a pair of second cutting portions 41, a pair of wing portions (air lift portion) 42, and a pair of second blade outer chamfered portions 43.

The second cutting portion 41 extends in the longitudinal direction along the second front end portion (front end portion) 46 located on the rotational direction Ra side at both end portions 45 in the longitudinal direction of the lower cutter blade 15. The second cutting portion 41 has a tapered cross section to be inclined downward from the upper surface 15a to the lower surface 15b in the rotational direction.

At both end portions 45 in the longitudinal direction, the wing portion 42 overhangs in a curved shape upward on the side opposite to the rotational direction Ra from the second rear end portion (rear end portion) 47 of the opposite side in the rotational direction Ra. The wing portion 42 is a portion for generating a swirling flow of air and an upward current, when the lower cutter blade 15 rotates in the rotational direction Ra.

By generating an upward current at the wing portion 42, the grass can be raised by the upward current, and the raised grass can be satisfactorily mown with the upper cutter blade 14.

By generating the swirling flow and the upward current with the wing portion 42, the mown lawn which is mown by the upper cutter blade 14 and the lower cutter blade 15 can turn and move inside the housing 11 to be finely cut.

The second blade outer chamfered portion 43 has a wing chamfered portion 51 and a blade chamfered portion 52.

The wing chamfered portion 51 is formed at the wing outer end portion 53 located on the outer side in the radial direction with respect to the rotary shaft 16a (axis center SC), in the wing portion 42. That is, the cross section of the wing chamfered portion 51 is formed in a tapered shape, by chamfering the wing outer end portion 53 to be inclined downward from the upper surface 15a to the lower surface 15b toward the outer side in the radial direction.

In the wing chamfered portion 51, for example, a thickness T3 of a leading edge 51a is set to be as thin as 0.1 to 1.0 mm, and a chamfered width W3 is set as 5 to 10 mm. This enables the inclined surface of the wing chamfered portion 51 to be smoothly inclined with respect to the upper surface 15a of the lower cutter blade 15. The wing chamfered portion 51 may be formed in a curved shape that bulges upward.

In the wing outer end portion 53, the blade outer end portion 54 is continuously formed in the circumferential direction (specifically, the rotational direction Ra) about the rotary shaft 16a (axis center SC). The wing outer end portion 53 and the blade outer end portion 54 form a second outer end portion 55 that extends along the circumferential direction (specifically, the wing outer end portion 53 extends in the circumferential direction and upward direction).

The blade outer end portion 54 extends from the outer end portion of the second front end portion 46 to the wing outer end portion 53 to the opposite side in the rotational direction Ra, and is continuously formed on the wing outer end portion 53.

The blade outer end portion 54 is formed to intersect the second front end portion 46. The blade outer end portion 54 and the second front end portion 46 intersect to form a corner portion 56. For example, although the corner portion 56 is formed to be substantially orthogonal to each other in a plan view in the embodiment, the present invention is not limited thereto. A blade chamfered portion 52 is formed on the blade outer end portion 54.

The blade chamfered portion 52 extends along the blade outer end portion 54 to be continuous with the wing chamfered portion 51 in the rotational direction Ra. Similarly to the wing chamfered portion 51, the cross section of the blade chamfered portion 52 is formed in a tapered shape, by chamfering the blade outer end portion 54 to be inclined downward from the upper surface 15a to the lower surface 15b toward the outer side in the radial direction.

In the blade chamfered portion 52, for example, similarly to the wing chamfered portion 51, a thickness T3 of a leading edge 52a is set to be as thin as 0.1 to 1.0 mm, and a chamfered width W3 is set as 5 to 10 mm. This enables the inclined surface of the blade chamfered portion 52 to be smoothly inclined with respect to the upper surface 15a of the lower cutter blade 15. The blade chamfered portion 52 may be formed in a curved shape that bulges upward.

The wing chamfered portion 51 and the blade chamfered portion 52 form a second blade outer chamfered portion 43 continuous in the rotational direction Ra. That is, the cross section of the second blade outer chamfered portion 43 is formed in a tapered shape, by chamfering the second outer end portion 55 to be inclined downward from the upper surface 15a to the lower surface 15b toward the outer side in the radial direction.

The second blade outer chamfered portion 43 is formed to intersect the second cutting portion 41. The intersection location between the second blade outer chamfered portion 43 and the second cutting portion 41 is the same part as the corner portion 56 of the blade outer end portion 54 and the second front end portion 46. The corner portion 56 is formed to be substantially orthogonal in a plan view, for example, in the embodiment. This makes it possible to simplify the shape of the corner portion 56 and to easily machine the corner portion 56 (that is, the lower cutter blade 15).

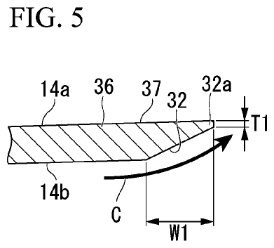

Next, an example of reducing noise such as wind noise generated by the rotation of the upper cutter blade 14 and the lower cutter blade 15 will be described on the basis of FIGS. 5, 8 to 10.

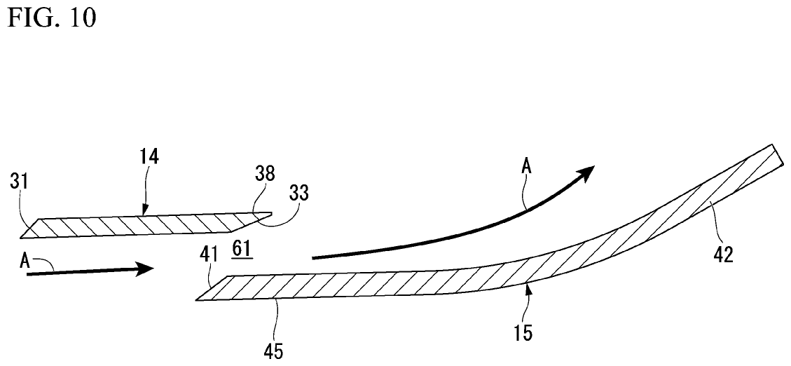

As shown in FIGS. 9 and 10, the upper cutter blade 14 is attached to the rotary shaft 16a so that the first cutting portion 31 is located on the rotational direction Ra side. The lower cutter blade 15 is attached to the rotary shaft 16a so that the second cutting portion 41 is located on the rotational direction Ra side.

In this state, the upper cutter blade 14 and the lower cutter blade 15 rotate in the rotational direction Ra to mow (cut) the grass with the first cutting portion 31 and the second cutting portion 41. At this time, by generating an upward current at the wing portion 42 of the lower cutter blade 15, the grass can be raised and the raised grass can be satisfactorily mown by the upper cutter blade 14.

When the upper cutter blade 14 and the lower cutter blade 15 rotate in the rotational direction Ra, air enters a space 61 between the upper cutter blade 14 and the lower cutter blade 15 as shown by an arrow A. The air entered is generated in the swirling flow and the upward current by the wing portion 42 of the lower cutter blade 15. Therefore, the mown lawn, which is mown by the upper cutter blade 14 and the lower cutter blade 15, can turn and move inside the housing 11 (see FIG. 1) to be finely cut.

Here, as shown in FIGS. 8 to 10, part of the air that has entered the space 61 can be allowed to smoothly flow outward as shown by an arrow B along the second blade outer chamfered portion 43 (that is, the blade chamfered portion 52 and the wing chamfered portion 51) of the lower cutter blade 15. As a result, turbulence in the air flow can be suppressed to a small extent, and it is possible to reduce noise such as wind noise generated by the rotation of the upper cutter blade 14 and the lower cutter blade 15.

As shown in FIGS. 9 and 10, a blade rear chamfered portion 33 is formed at the first rear end portion 38 of the upper cutter blade 14. Part of the air that has entered the space 61 can be allowed to smoothly flow rearward by the blade rear chamfered portion 33 as shown by the arrow A. As a result, turbulence in the air flow can be suppressed to a small extent, and it is possible to further satisfactorily reduce noise such as wind noise generated by the rotation of the upper cutter blade 14 and the lower cutter blade 15.

Further, as shown in FIGS. 5, 9, and 10, a first blade outer chamfered portion 32 is formed at the first outer end portion 37 of the upper cutter blade 14. Part of the air that has entered the space 61 can be allowed to smoothly flow outward by the first blade outer chamfered portion 32 as shown by an arrow C. As a result, turbulence in the air flow can be suppressed to a small extent, and it is possible to further satisfactorily reduce noise such as wind noise generated by the rotation of the upper cutter blade 14 and the lower cutter blade 15.

Here, the lower cutter blade 15 is chamfered so that the second blade outer chamfered portion 43 (that is, the blade chamfered portion 52 and the wing chamfered portion 51) is inclined downward. Therefore, even if another upper cutter blade 14 is provided above the lower cutter blade 15, the air guided along the lower cutter blade 15 can be allowed to smoothly flow outward by the second blade outer chamfered portion 43.

As a result, turbulence in the air flow can be suppressed to a small extent, and it is possible to further satisfactorily reduce noise such as wind noise generated by the rotation of the upper cutter blade 14 and the lower cutter blade 15.

Next, an example of mowing grass with the upper cutter blade 14 and the lower cutter blade 15 will be described on the basis of FIGS. 3, 5, 6, and 8.

As shown in FIGS. 3, 5, 6, and 8, the rotation of the lower cutter blade 15 causes the wing portion 42 of the lower cutter blade 15 to generate a swirling flow and an upward current. Therefore, the mown lawn, which is mown by the upper cutter blade 14 and the lower cutter blade 15, turns and moves inside the housing 11 (see FIG. 1) due to the swirling flow and the upward current. When the mown lawn turns and moves, the mown lawn can be guided to the upper cutter blade 14 and the lower cutter blade 15. As a result, the mown lawn is finely cut by the upper cutter blade 14 and the lower cutter blade 15.

Here, the thickness of the leading edge (each of the leading edges 52a and 51a of the blade chamfered portion 52 and the wing chamfered portion 51) of the second blade outer chamfered portion 43 is formed to be thin. Further, the thickness of the leading edge 32a of the first blade outer chamfered portion 32 is formed to be thin. As a result, the mown lawn can be cut more finely by the upper cutter blade 14 and the lower cutter blade 15.

At this time, it is conceivable that the mown lawn inside the housing 11 enters between the housing 11 and the second blade outer chamfered portion 43 (that is, the blade chamfered portion 52 and the wing chamfered portion 51). Alternatively, it is conceivable that the mown lawn enters between the housing 11 and the first blade outer chamfered portion 32.

Even in this case, it is possible to satisfactorily mow the mown lawn that has entered, by the leading edge of the second blade outer chamfered portion 43 or the leading edge 32a of the first blade outer chamfered portion 32 which are formed to be thin. As a result, it is possible to prevent the mown lawn from being caught between the housing 11 and the second blade outer chamfered portion 43, or the mown lawn from being caught between the housing 11 and the first blade outer chamfered portion 32. Therefore, energy saving of the mower 10 can be realized.

The second blade outer chamfered portion 43 and the second cutting portion 41 intersect to form a corner portion 56. Therefore, the grass can be firmly grasped by the corner portion 56, and the grasped grass can be mown by the upper cutter blade 14 and the lower cutter blade 15 (particularly, the lower cutter blade 15). This makes it possible to more satisfactorily secure the cutting property of the grass, and realize the energy saving of the mower 10.

Although the preferred embodiments of the present invention have been described above, the present invention is not limited thereto, configurations can be added, omitted, replaced, and other changes can be made without departing from the spirit of the present invention, and the above-mentioned modification examples can also be appropriately combined.

For example, in the above-described embodiment, although the walking type self-propelled mower is provided as an example of the mower 10, the mower is not limited thereto. As another example, the present invention may be applied to other mowers such as a riding self-propelled mower and an unmanned mower.

In the above-described embodiment, although an example including the upper cutter blade 14 and the lower cutter blade 15 has been described, the present invention is not limited thereto. As another example, only the lower cutter blade 15 may be provided.

Further, in the above-described embodiment, although an example in which the second blade outer chamfered portion 43 (that is, the wing chamfered portion 51 and the blade chamfered portion 52) is formed on the lower cutter blade 15 has been described, the present invention is not limited thereto. As another example, only the wing chamfered portion 51 may be formed.

In the above-described embodiment, although an example in which the thickness T1 of the leading edge 32a is formed to be 0.1 to 1.0 mm and the chamfered width W1 is formed to be 5 to 10 mm in the first blade outer chamfered portion 32 has been described, the example is not limited to this shape.

Further, although an example in which the thickness T2 of the leading edge 33a is formed to be 0.1 to 1.0 mm and the chamfered width W2 is formed to be 5 to 10 mm in the blade rear chamfered portion 33 has been described, the example is not limited to this shape.

Although an example in which the thickness T3 of the leading edge 51a is formed to be 0.1 to 1.0 mm and the chamfered width W3 is formed to be 5 to 10 mm in the wing chamfered portion 51 has been described, the example is not limited to this shape.

Further, although an example in which the thickness T3 of the leading edge 52a is formed to be 0.1 to 1.0 mm and the chamfered width W3 is formed to be 5 to 10 mm in the blade chamfered portion 52 has been described, the example is not limited to this shape.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10 Mower
11 Housing
14 Upper cutter blade (upper cutter blade)
14a, 15a Upper surface
14b, 15b Lower surface
15 Lower cutter blade (cutter blade, lower cutter blade)
16a Rotary shaft
32 First blade chamfered portion (upper blade chamfered portion)
33 Blade rear chamfered portion
35 Both end portions of upper cutter blade
37 First outer end portion (upper outer end portion)
38 First rear end portion (upper rear end portion)
42 Wing portion
43 Second blade outer chamfered portion
45 Both end portions of lower cutter blade
46 Second front end portion (front end portion)
47 Second rear end portion (rear end portion)
51 Wing chamfered portion
52 Blade chamfered portion
53 Wing outer end portion
54 Blade outer end portion
56 Corner portion
Ra Rotational direction

1. (canceled)

2. A mower, comprising:
a housing with an open bottom;
a rotary shaft supported in a vertical direction inside the housing; and
a cutter blade which is housed inside the housing to be rotatable with the rotary shaft as a rotation center and extends from the rotary shaft to both of opposing sides of the housing in a radial direction;
wherein the cutter blade has
a wing portion which overhangs upward and rearward that is an opposite side in a rotational direction of the cutter blade from a rear end portion located on an opposite side in the rotational direction of the cutter blade, at both of end portions of the cutter blade in a longitudinal direction,
wherein a wing portion has a wing chamfered portion at which a wing outer end portion located on an outer side in the radial direction of the wing portion is chamfered to be inclined from an upper surface to a lower surface toward the outer side in the radial direction and is chamfered in tapered cross section to decrease in thickness, and
a cutting portion which extends in the longitudinal direction along the front end portion of the cutter blade.

3. The mower according to claim 2,
wherein the cutter blade has a blade outer end portion which extends rearward from an outer edge in the radial direction at a front end portion located on the front side in the rotational direction to the wing outer end portion and continuous with the wing outer end portion, at both of end portions of the cutter blade in a longitudinal direction, and
wherein the blade outer end portion and the front end portion intersect to form a corner portion.

4. The mower according to claim 2,
wherein the cutter blade has a blade chamfered portion at which the blade outer end portion is chamfered to be inclined from the upper surface to the lower surface toward the outer side in the radial direction and is chamfered in tapered cross section to decrease in thickness.

5. The mower according to claim 2,
wherein the rotary shaft is provided with the cutter blade and an upper cutter blade located above the cutter blade.

6. The mower according to claim 5,
wherein the upper cutter blade has a blade outer chamfered portion at which an outer end portion located on an outer side in the radial direction is chamfered to be inclined from a lower surface to an upper surface toward the outer side in the radial direction and is chamfered in tapered cross section to decrease in thickness, at both of end portions of the upper cutter blade in a longitudinal direction.

7. The mower according to claim 6,
wherein the upper cutter blade has a blade rear chamfered portion at which an another rear end portion located on the opposite side in the rotational direction of the cutter blade is chamfered to be inclined from the lower surface to the upper surface toward the rearward and is chamfered in tapered cross section to decrease in thickness.
